(19) United States
(12) Patent Application Publication
(10) Pub. No.: US 2010/0326229 A1
(43) Pub. Date: Dec. 30, 2010

(54) STEERING WHEEL SWITCH MODULE

(75) Inventors: Michael Gerharz, Koeln (DE); Hans Hoffmann, Frechen (DE)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/824,574

(22) Filed: Jun. 28, 2010

(30) Foreign Application Priority Data
Jun. 26, 2009 (DE) 10 2009 027 232.1

(51) Int. Cl. B62D 1/16; H01H 9/00

(52) U.S. Cl. 74/492; 200/61.57

(57) ABSTRACT

A multi-function switch module which rotates along with a steering wheel of an automotive vehicle is arranged between the spokes of the steering wheel and includes a quadruple switching rocker and at least one pull button.

### CROSS-REFERENCE TO RELATED APPLICATIONS

This application claims foreign priority benefits under 35 U.S.C §119(a)-(d) to DE 10 2009 027 232.1, filed Jun. 26, 2009, which is hereby incorporated by reference in its entirety.

### BACKGROUND

1. Technical Field

The invention relates to a switch module mountable to a steering wheel of an automotive vehicle.

2. Background Art

In modern automotive vehicles, in particular passenger cars, more and more functions are provided which have to be controlled/activated by the driver in an ergonomic and efficient way while minimizing distractions to the driver.

From the ergonomic point of view, a suitable mounting location for the switches will permit the driver to control the switches without removing her/his hands from the steering wheel, and also to keep the switches in his/her field of vision without looking away from the roadway and the traffic situation.

However, the space on and adjacent to the steering wheel is usually very limited.

In addition to the customary location of switches on the surface of the steering wheel facing the driver, in particular the hub and the spokes, switches are also known to be arranged between the spokes. In motor racing vehicles, such a switch location is sometimes used for gear selection, where the switches are embodied as push-pull buttons or tabs. See, for example, EP 0 941 886 A2.

It would be desirable to have a steering wheel switch module with which a large number of vehicle functions, apart from the gear speed, can be switched, in an ergonomic and intuitive way, and which at the same time nevertheless has dimensions which are as small as possible, so that it can be readily mounted between the spokes of conventional steering wheels.

### SUMMARY

In a disclosed embodiment, a switch module mountable on a steering wheel for rotation along with the steering wheel comprises a quadruple switching rocker actuatable by pressing in a first direction and at least one pull button actuatable by pressing in an opposite second direction. The switch module permits actuation of five functions in an ergonomic and intuitive way in an extremely small space.

In another disclosed embodiment, a steering wheel assembly comprises a steering wheel having a central hub, an outer rim, and a plurality of spokes connecting the hub with the rim; and a switch module arranged for rotation along with the steering wheel, the switch module comprising a quadruple switching rocker and at least one pull button.

In another disclosed embodiment, a steering wheel assembly comprises a steering wheel having a central hub, an outer rim, and a plurality of spokes connecting the hub with the rim; and a switch module disposed adjacent the hub and on a non-driver-facing side of the steering wheel and between adjacent spokes. The switch module comprises a quadruple switching rocker having an actuation surface oriented toward a driver-facing side of the steering wheel and at least one pull button projecting toward the rim and actuatable by pressing toward the driver-facing side of the steering wheel.

### BRIEF DESCRIPTION OF THE DRAWINGS

Embodiments of the present invention will now be described by way of example only with reference to accompanying drawings in which:

FIG. 1 is a schematic plan view of a steering wheel having two activation devices which are configured according to the invention, for controlling the audio functions and for controlling the cruise controller, and

FIG. 2 is a perspective schematic view of a switching module.

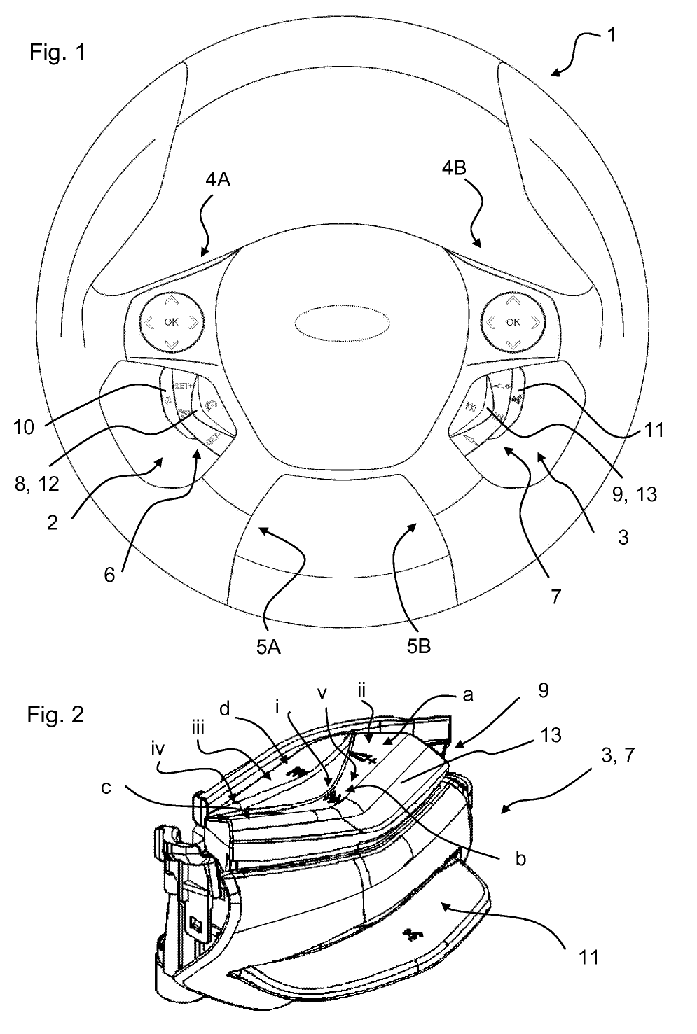

### DETAILED DESCRIPTION

The figures illustrate a pair of manual activation devices 2, 3 which rotate along with a steering wheel 1. For example, in one possible embodiment, control of various functions of an audio system (not shown) may be controlled using left-hand activation device 2 and control of various functions of a cruise control system (not shown) may be controlled using right-hand activation device 3.

The activation devices 2, 3 are respectively composed of steering wheel switch modules 6, 7 which are arranged on the steering wheel 1 between the spokes 4, 5 thereof, adjacent the central or hub portion of the steering wheel. The switch modules 6, 7 are located on the side of the steering wheel 1 oriented away from the driver and toward an instrument panel (the non-driver-facing side). The left-hand activation 2 is arranged here between the adjacent left-hand spokes 4A, 5A and the right-hand activation device 3 is arranged here between the adjacent right-hand spokes 4B, 5B. The switch modules 6, 7 are located to be accessible and visible to the driver through the openings between the respective pairs of adjacent spokes 4, 5.

In the embodiment shown, the switch modules 6, 7 are mounted relative to steering wheel 1 so as to permit the driver to actuate the switches without removing her/his hands from the steering wheel, and also to keep the switches in his/her field of vision without looking away from the roadway and the traffic situation.

Each steering wheel switch module 6, 7 is provided with a switching device which comprises a quadruple switching rocker 8, 9 and at least one pull button 10, 11.

The quadruple switching rocker 8, 9 is arranged in each case on the surface of the steering wheel switch module 6, 7 facing the driver (the driver-facing side of the steering wheel), so that said rocker can be controlled by the driver's respective thumbs (see above).

Each quadruple switching rocker 8, 9 comprises here a single switching plate 12, 13 which is suspended centrally in such a way that four different functions can be triggered by depressing four distinct activation regions a, b, c, d of the switching plate surface.

Distances between the otherwise customary individual buttons can therefore be dispensed with and the space requirement becomes correspondingly smaller.

In order to permit ergonomic and safe operator control even without continuous visual contact with the switching rocker 8, 9, the activation regions a, b, c, d are separated from one another by curvatures of the actuation surface of the switching plate 12, 13.

As is apparent from FIG. 2, in which the module 7 is illustrated by way of example, the actuation surface of the switching plate 13 is curved three-dimensionally.

A depression i is therefore arranged between the activation regions a and c, and at the same time an inclination ii of the actuation surface in the direction of the hub of the steering wheel (also in the direction of the activation region d) is provided. Activation region d is in turn offset with an elevated portion iii with respect to the activation regions a and c. In addition, the surface is provided with an elevated portion iv, which extends to the outer edge with a curved portion v between the activation regions a and c. The fourth activation region b is arranged toward the outer edge of the switching plate 13 and lies in the depression and the curvature.

The activation regions are preferably provided with symbols which indicate their function and which may be back-lit for improved visibility in dark conditions.

The switching functions are therefore “separated” from one another, and can be perceived as such, both visually and tactilely, despite having a common switching plate 12, 13.

A pull button 10, 11 protrudes outwardly from the housing of the respective steering wheel switch module 6, 7 in the direction of the steering wheel rim, i.e. in the case of the left-hand steering wheel switch module 6 the pull button 10 protrudes to the left.

At the height or depth of the steering wheel switch module 6, 7, the pull button 10, 11 is arranged in such a way that it can be reached easily by the driver's fingers in order to be pulled in the direction of the driver, hence the designation pull button. In this context, it is arranged on the module housing respectively closer to the spokes 4A or 4B. Since the driver's hands are usually arranged at those locations, the pull button 10, 11 can be reached easily at any time.

Each quadruple switching rocker 8, 9 can be activated with the thumb and the pull button 10, 11 can be activated with the other four fingers from the opposite side during driving, without the driver letting go of the steering wheel 1.

Depending on the requirements and functionality, more than one pull button may also be present. It is therefore within the scope of the invention if the pull tab is divided into multiple individual buttons which each button serving as a switch for a separate function. However, from the ergonomic and configuration point of view it may be desirable if the divided buttons retain the “original” configuration of the individual pull button or are divided within the dimensions thereof.

The steering wheel switch modules 6, 7 may comprise a printed circuit board on which the required electronics are accommodated. These also include the respective switches per se. In this context, said switches may be arranged such that one switch is provided on a first surface of the printed circuit board for the pull button 10, 11, and at the same time four switches are provided on an opposite surface of the board for activation by the quadruple switching rocker 8, 9. This permits a compact design of the printed circuit boards and therefore of the module housings.

The two modules 6, 7 preferably behave with respect to one another in terms of their configuration and arrangement of the operator control elements like the left hand and right hand, and may therefore be configured in a mirror-inverted fashion with respect to one another.

The quadruple switching rocker has the advantage of saving space since spaced-apart individual buttons with a distance between the switching surfaces are not used. Furthermore, the pull switch provides the advantage that owing to the effective direction which is reversed in relation to the quadruple switching rocker said pull switch can act on a switch which is arranged on the rear side of the corresponding printed circuit board. The printed circuit board can therefore be made smaller in terms of area.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. A switch module mountable on a steering wheel for rotation along with the steering wheel, the module comprising a quadruple switching rocker actuatable by pressing in a first direction and at least one pull button actuatable by pressing in an opposite second direction.

2. The apparatus of claim 1, wherein the quadruple switching rocker is arranged on a surface of the switch module oriented toward a driver-facing side of the steering wheel.

3. The apparatus of claim 1, wherein the switch module is adapted to be mounted to the steering wheel in a position accessible between adjacent spokes of the steering wheel.

4. The apparatus of claim 1, wherein the quadruple switching rocker comprises a switching plate suspended centrally and comprising four distinct activation regions such that depressing each of the four activation regions triggers a different function.

5. The apparatus of claim 4, wherein the activation regions are separated from one another by curvatures of an actuation surface of the switching plate.

6. The apparatus of claim 1, wherein the pull button protrudes outwardly from a housing of the switch module toward a rim of the steering wheel.

7. The apparatus of claim 1, wherein the pull button is arranged such that it activates a switch on a first side of a printed circuit board, and the quadruple switching rocker is arranged in such a way that it activates four switches on an opposite second side of the printed circuit board.

8. A steering wheel assembly comprising:
a steering wheel having a central hub, an outer rim, and a plurality of spokes connecting the hub with the rim; and
a switch module arranged for rotation along with the steering wheel, the switch module comprising a quadruple switching rocker and at least one pull button.

9. The apparatus of claim 8, wherein the quadruple switching rocker is on a surface of the switch module oriented toward a driver-facing side of the steering wheel.

10. The apparatus of claim 8, wherein the switch module is mounted for access between spokes of the steering wheel.

11. The apparatus of claim 8, wherein the quadruple switching rocker comprises a switching plate suspended centrally and having an actuation surface comprising four distinct activation regions such that depressing each of the four activation regions triggers a different function.

12. The apparatus of claim 4, wherein the activation regions are separated from one another by curvatures of the actuation surface.

13. The apparatus of claim 8, wherein the pull button protrudes outwardly from a housing of the switch module toward the rim of the steering wheel.

14. The apparatus of claim 8, wherein the pull button is arranged such that it activates a switch mounted on a first side of a printed circuit board, and the quadruple switching rocker is arranged such that it activates four switches mounted on an opposite second side of the printed circuit board.

15. A steering wheel assembly comprising:
a steering wheel having a central hub, an outer rim, and a plurality of spokes connecting the hub with the rim; and
a switch module disposed adjacent the hub and on a non-driver-facing side of the steering wheel and between adjacent spokes, the switch module comprising a quadruple switching rocker having an actuation surface oriented toward a driver-facing side of the steering wheel and at least one pull button projecting toward the rim and actuatable by pressing toward the driver-facing side of the steering wheel.

16. The apparatus of claim 15, wherein the quadruple switching rocker comprises a switching plate suspended centrally, the actuation surface disposed on the switching plate and comprising four distinct activation regions such that depressing each of the four activation regions triggers a different function.

17. The apparatus of claim 16, wherein the activation regions are separated from one another by curvatures of the actuation surface.
